(19) United States
(12) Patent Application Publication
(10) Pub. No.: US 2026/0148755 A1
(43) Pub. Date: May 28, 2026

(54) EFFECT PROCESSING METHOD, ELECTRONIC DEVICE, AND STORAGE MEDIUM

(71) Applicants: Beijing Zitiao Network Technology Co., Ltd., Beijing (CN); LEMON INC., Grand Cayman (CN)

(72) Inventors: Jingqing LIN, Beijing (CN); Chen HE, CULVER CITY, CA (US); Kristoffer SOLOMON, CULVER CITY, CA (US); Kewei CHEN, Beijing (CN); Liyou XU, CULVER CITY, CA (US)

(21) Appl. No.: 19/400,680

(22) Filed: Nov. 25, 2025

(30) Foreign Application Priority Data
Nov. 25, 2024 (CN) 202411698931.3

(51) Int. Cl. G11B 27/036; G06F 3/0482; G06F 3/04847; H04N 23/63

(52) U.S. Cl. CPC G11B 27/036; H04N 23/632; G06F 3/0482; G06F 3/04847

(57) ABSTRACT

An effect processing method, an electronic device and a non-transitory storage medium are provided. The method includes: receiving an effect adding operation for a first effect file via a first interface, displaying a video editing item corresponding to the first effect file, and generating a first effect video corresponding to the first effect file and displaying video preview information of the first effect video, where the first effect file includes a first video file; and receiving a video editing operation for the first effect video via the video editing item, determining a second video file according to the video editing operation, generating a second effect video corresponding to the first effect file according to the second video file, and displaying video preview information of the second effect video.

### CROSS-REFERENCE TO RELATED APPLICATION

This application claims the priority to the Chinese Patent Application, No. 202411698931.3, which was filed on Nov. 25, 2024, which is incorporated herein by reference in its entirety.

### TECHNICAL FIELD

Embodiments of the present disclosure relate to the field of computer processing technology, and in particular, to an effect processing method, an electronic device, and a storage medium.

### BACKGROUND

In an image processing or video production scenario, more and more users add effect data for enriching the displaying effects of images or videos.

Effect files are typically created by using a professional effect production tool, and then deployed into an effect App for use by users. In an application scenario of an effect file, the content of the effect file is often fixed. Therefore, the effect display result presented by the effect file is monotonous. Also, interaction manners with the effect file supported in the effect App are often limited to whether the effect file is selected. There are few interaction manners, which affecting the use experience of the effect file.

### SUMMARY

The present disclosure provides an effect processing method and apparatus, an electronic device.

In a first aspect, the embodiments of the present disclosure provide an effect processing method, including:
receiving an effect adding operation for a first effect file via a first interface, displaying a video editing item corresponding to the first effect file, and generating a first effect video corresponding to the first effect file and displaying video preview information of the first effect video, where the first effect file includes a first video file; and
   receiving a video editing operation for the first effect video via the video editing item, determining a second video file according to the video editing operation, generating a second effect video corresponding to the first effect file according to the second video file, and displaying video preview information of the second effect video.

In a second aspect, the embodiments of the present disclosure provide an effect processing apparatus, including:
an effect file adding module configured to receive an effect adding operation for a first effect file via a first interface, display a video editing item corresponding to the first effect file, and generate a first effect video corresponding to the first effect file and display video preview information of the first effect video, where the first effect file includes a first video file; and
an effect video editing module configured to receive a video editing operation for the first effect video via the video editing item, determine a second video file according to the video editing operation, generate a second effect video corresponding to the first effect file according to the second video file, and show video preview information of the second effect video.

In a third aspect, the embodiments of the present disclosure provide an electronic device, including:
one or more processors; and
a storage apparatus, configured to store one or more programs,
where the one or more programs, when executed by the one or more processors, cause the one or more processors to implement the effect processing method as described in any one of the embodiments of the present disclosure.

In a fourth aspect, the embodiments of the present disclosure provide a storage medium including computer-executable instructions, where the computer-executable instructions, when executed by a computer processor, implement the effect processing method as described in any one of the embodiments of the present disclosure.

In a fifth aspect, the embodiments of the present disclosure provide a computer program product, including a computer program which, when executed by a processor, implements the effect processing method as described in any one of the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and components and elements may not necessarily be drawn to scale.

FIG. 1 is a flowchart of an effect processing method provided by an embodiment of the present disclosure;

FIG. 2 is a schematic diagram of an interface effect of a first interface provided by an embodiment of the present disclosure;

FIG. 3 is a flowchart of another effect processing method provided by an embodiment of the present disclosure;

FIG. 4 is a flowchart of another effect processing method provided by an embodiment of the present disclosure;

FIG. 5 is a flowchart of another effect processing method provided by an embodiment of the present disclosure;

FIG. 6 is a flowchart of another effect processing method provided by an embodiment of the present disclosure;

FIG. 7 is a schematic diagram of an interface effect of a second interface provided by an embodiment of the present disclosure;

FIG. 8 is a structural schematic diagram of an effect processing apparatus provided by an embodiment of the present disclosure; and

FIG. 9 is a structural schematic diagram of an electronic device provided by an embodiment of the present disclosure for implementing the embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that Modifications of “one” and “more” mentioned in the present disclosure are schematic rather than restrictive, and those skilled in the art should understand that unless otherwise explicitly stated in the context, it should be understood as “one or more”.

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

It may be understood that the data involved in the technical solutions (including but not limited to the data itself, data acquisition or use) should comply with the requirements of corresponding laws, regulations and relevant provisions.

The present disclosure provides an effect processing method and apparatus, an electronic device, a storage medium, and a program product to realize self-defined edition of an effect video generated from an effect file based on a user's interface interaction operation for generating a new effect video.

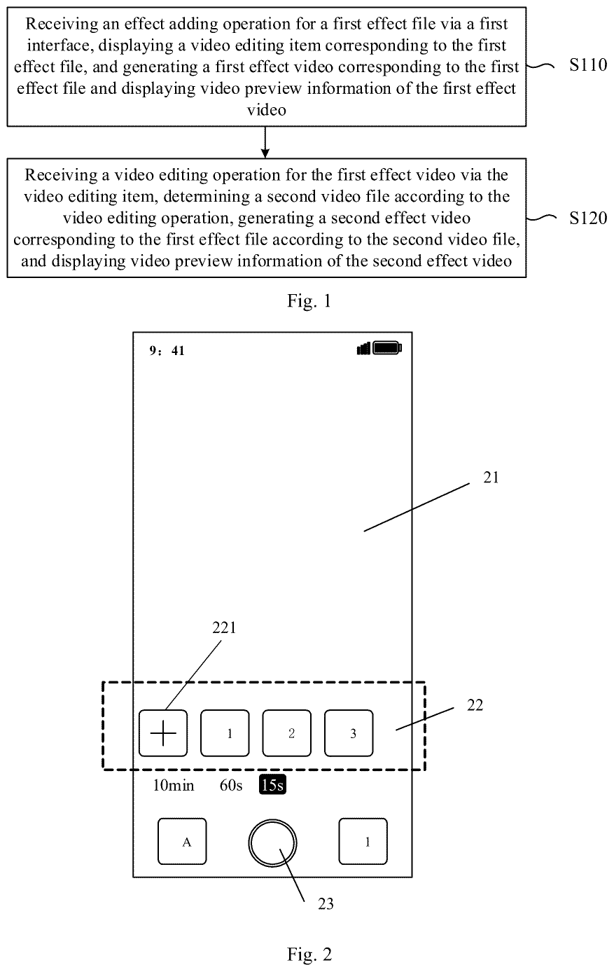

FIG. 1 is a flowchart of an effect processing method provided by an embodiment of the present disclosure. This embodiment of the present disclosure is applicable to a scenario of editing the media content of an effect file. The effect processing method may be performed by an effect processing apparatus which may be implemented in the form of software and/or hardware and optionally implemented by an electronic device. The electronic device may be a mobile terminal, a personal computer (PC), a server, or the like.

As shown in FIG. 1, the effect processing method of the present embodiment may include the following steps.

S110: receiving an effect adding operation for a first effect file via a first interface, displaying a video editing item corresponding to the first effect file, and generating a first effect video corresponding to the first effect file and displaying video preview information of the first effect video.

The first interface may be construed as a visual editing interface that supports a user in editing effect videos and displays video contents. Optionally, the first interface includes an effect video displaying region, an effect file selection region and/or an effect file editing region, etc. The first effect file may be construed as an effect that meets the user's effect editing demand and/or effect video generation demand. The first effect file may be an effect of any type. Optionally, the first effect file may be an effect including a video file; and/or the first effect file may be effect that supports the user in loading videos and generation of an effect video based on the loaded video; and/or the first effect file may be an effect of an effect video generated based on the edited video after the included video or the loaded video is edited, and so on.

In an embodiment of the present disclosure, the first effect file may include a first video file. The first video file may be construed as a template video file or a default video file in the first effect file. The video file may be used to show the effect of the first effect file. The first video file may be a video added to the effect file during the generation of the first effect file. Alternatively, the first video file may also be a video acquired from self-defined updating on the original video file during the effect editing of the first effect file.

It should be noted that the first effect file may further include at least one effect element capable of acting on an effect acting object. Exemplarily, the first effect file may further include a facial makeup effect, a face stylizing effect, a facial sticker effect, etc. The effect adding operation may be construed as an operation of adding an effect to a corresponding region in the interface. Optionally, a first interface includes an effect identifier of at least one effect file, and the effect adding operation includes an identifier trigger operation for the effect identifier.

The video editing item may be used to edit the video file included in the first effect file. The video editing item may be construed as an interactive operation entry for editing the video file included in the first effect file. Optionally, the video editing item includes a video identifier corresponding to at least one candidate video and/or a video uploading control.

The first effect video may be construed as an effect video generated based on the first video file in the first effect file. The first effect video may be an effect video acquired by processing the first video file according to a preset effect displaying logic in the first effect file. The video preview information may be used for previewing the effect of the generated effect video before posting or storing the effect video. The video preview information may be construed as a preview effect of the first effect video. The video preview information may be displayed in a plurality of ways. Optionally, the video preview information may be displayed within a preset display region in the first interface. Alternatively, the video preview information may be displayed in the form of a pop-up window in the first interface. Alternatively, the video preview information may be displayed in an effect preview interface instead of the first interface, and so on.

In an embodiment of the present disclosure, after displaying the first interface, the displayed first interface may include the first effect file therein. Further, in response to detecting the effect adding operation for the first effect file, the video editing item corresponding to the first effect file may be displayed. Moreover, the first video file may be processed according to the effect displaying logic in the first video file to generate the first effect video corresponding to the first effect file, and the video preview information of the first effect video is displayed.

It should be noted that an upper limit of a video display duration may also be preset for the generation of the effect video. Thus, for generating the first effect video corresponding to the first effect file, the first video file may be processed in accordance with the preset upper limit of the video display duration such that the preset upper limit of the video display duration is used as an upper limit of a video duration of the first effect video. Optionally, if the video duration of the first video file is greater than the preset upper limit of the video display duration, the first video file may be clipped in accordance with the preset upper limit of the video display duration, and the first effect video is generated according to the clipped first video file. If the video duration of the first video file is less than the preset upper limit of the video display duration, stitching may be performed on the first video file, i.e., a copy of the first video file is stitched to the end of the first video file. Thus, the first effect video may be generated according to the stitched first video file such that the video content of the first effect video is cyclically played video content of the first video file.

In an embodiment of the present disclosure, in order to enable a client to rapidly recognize the effect file added by triggering as the first effect file and show the corresponding video editing item thereof, optionally, the first effect file is an effect file added with a preset file identifier. The step of receiving the effect adding operation for the first effect file via the first interface and displaying the video editing item corresponding to the first effect file includes: displaying the first interface, where an effect identifier corresponding to at least one effect file is displayed on the first interface; in response to an identifier trigger operation for the effect identifier, determining a selected effect file according to the identifier trigger operation and the effect identifier; and in response to the selected effect file being added with the preset file identifier, displaying the video editing item corresponding to the selected effect file.

The preset file identifier may be information for identifying the first effect file. Alternatively, the preset file identifier may also be construed as information for distinguishing the first effect file from other effect files. The preset file identifier may be any type of information. Optionally, the preset file identifier may be a file name, a file hash value, file metadata, or self-defined identification information, etc. Exemplarily, the preset file identifier may be “Video Picker”. The effect file may be an effect edited in advance and supporting use by users. The effect identifier may be information for identifying the effect file. Optionally, the effect identifier may include at least one of an effect name, an effect thumbnail, and other identification information that can be used for identifying the effect file. The identifier trigger operation may be an operation for triggering to select an effect identifier.

As an optional implementation of the present embodiment of the present disclosure, in response to an interface display operation being received, the first interface is displayed. The effect identifier corresponding to at least one effect file is displayed in the first interface. The corresponding effect identifier may be selected by inputting a trigger operation for the effect identifier. Further, in response to the identifier trigger operation for the effect identifier being received, the selected effect identifier is determined according to the identifier trigger operation, and the effect file corresponding to the selected effect identifier is used as the selected effect file. Further, whether the selected effect file is added with the preset file identifier may be determined. Further, in response to the selected effect file being added with the preset file identifier, the selected effect file may be used as the first effect file. The video editing item corresponding to the first effect file is determined and displayed.

S120: receiving a video editing operation for the first effect video via the video editing item, determining a second video file according to the video editing operation, generating a second effect video corresponding to the first effect file according to the second video file, and displaying video preview information of the second effect video.

The video editing operation may be construed as an operation for editing the first video file corresponding to the first effect video. The video editing operation may be used for switching a video file for generating an effect video. Optionally, the video editing operation may include a video selecting operation, a video uploading operation and/or a video shooting operation, etc. The second video file may be construed as a video file that can be used to replace the first video file corresponding to the first effect video. Optionally, the second video file may be a video file acquired from a first storage space (e.g., a video library of application software, or a terminal photo album) in response to a selection trigger operation, or may be a video file uploaded by an external device, etc. The second effect video may be construed as an effect video generated based on the second video file. The second effect video may be an effect video acquired by processing the second video file according to the preset effect displaying logic in the first effect file. The video preview information may be used for previewing the effect of the generated effect video before posting or storing the effect video. The video preview information may be construed as a preview effect of the second effect video.

In an embodiment of the present disclosure, the video editing operation of the first effect video may be input via the video editing item to edit the first video file corresponding to the first effect video. Further, in response to the video editing operation for the first effect video being received, the second video file may be determined according to the video editing operation. Further, the second video file may be processed according to the effect displaying logic in the first effect file to obtain the second effect video corresponding to the first effect file, and in response to an editing completion instruction being received, the video preview information of the second effect video is displayed.

As an optional implementation of the present embodiment of the present disclosure, the video editing item includes a video identifier corresponding to at least one candidate video file, and the video editing operation includes the video selecting operation. In response to the video selecting operation for a video identifier being received, the selected video identifier may be determined according to the video selecting operation. Further, the candidate video file corresponding to the selected video identifier may be determined, and is used as the second video file. The candidate video file may be a video file stored in the video library of the application software.

As another optional implementation of the present embodiment of the present disclosure, the video editing item includes a video uploading control, and the video editing operation includes a video uploading operation. In response to a control trigger operation for the video uploading control being received, a display interface of a terminal photo album may be displayed. The display interface of the terminal photo album includes therein a video identifier corresponding to at least one video file to be uploaded. Further, in response to the identifier trigger operation for the video identifier being received, the video file to be uploaded corresponding to the triggered video identifier may be determined. The video file to be uploaded is uploaded to an effect processing terminal, and the uploaded video file is used as the second video file.

Exemplarily, FIG. 2 is a schematic diagram of an interface effect of a first interface provided by an embodiment of the present disclosure. As shown in FIG. 2, the first interface includes a video displaying region 21, an effect file editing region 22, and a shooting control 23. In response to a selected effect file A being determined as the first effect file, the video preview information of the first effect video corresponding to the effect file A may be displayed on the video displaying region 21, and the effect file editing region 22 is displayed. The effect file editing region 22 includes the video editing item that includes the video uploading control 221 and 3 video identifiers, namely video identifier 1, video identifier 2, and video identifier 3. In response to the identifier trigger operation for the video identifier 1 being received, the video file corresponding to the video identifier 1 may be used as the second video file, and the second video file is processed in accordance with the determined video display duration of 15 seconds. Thus, the second effect video corresponding to the effect file A may be generated based on the processed second video file, and the video preview information of the second effect video is displayed on the video displaying region 21. In response to a control trigger operation for the shooting control 23 being received, a first shot video may be determined according to the control trigger operation. Thus, the first shot video and the second effect video may be rendered in accordance with the effect processing logic of the effect file A to obtain a third effect video, and the video preview information of the third effect video is displayed on the video displaying region 21.

It should be noted that in order to ensure that the default settings of the first effect file can be recovered if an edit undo operation for the video editing operation is received, that is, the first video file can be acquired, and the first effect video is generated according to the first video file, in a case where the second video file has been determined, the first effect file in the first effect file is not replaced based on the second video file, and the second video file is directly stored in other storage space such that the second effect video corresponding to the first effect file is generated with the second video file in the other storage space. Further, in response to the edit undo operation for the video editing operation being received, the second video file stored in the other storage space is directly deleted. In the case where the second video file is not stored in the other storage space, the first effect video is generated according to the first video file in the first effect file, and the video preview information of the first effect video is displayed.

According to the technical solutions of the embodiments of the present disclosure, the effect adding operation for the first effect file is received via the first interface, and the video editing item corresponding to the first effect file is displayed. The first effect video corresponding to the first effect file is generated and the video preview information of the first effect video is displayed. It is thus realized that the effect preview display function and the effect editing function are integrated into the same interface, providing an operation entry for editing the preset video file in the first effect file. Moreover, the first effect file includes the first video file such that the effect displaying content and the displaying effects are enriched. Further, the video editing operation for the first effect video is received via the video editing item, and the second video file is determined according to the video editing operation. The second effect video corresponding to the first effect file is generated according to the second video file, and the video preview information of the second effect video is displayed. The technical problems of limited interaction manners with effect files and single effect display result of the effect files are solved. It is realized that self-defined editing of the video file in the effect file can be performed by using a simple interface interaction operation to generate a new effect video. Thus, the flexibility of effect processing is improved. The effect display results of the effect files are enriched, and the effect use experience of the effect file is enhanced.

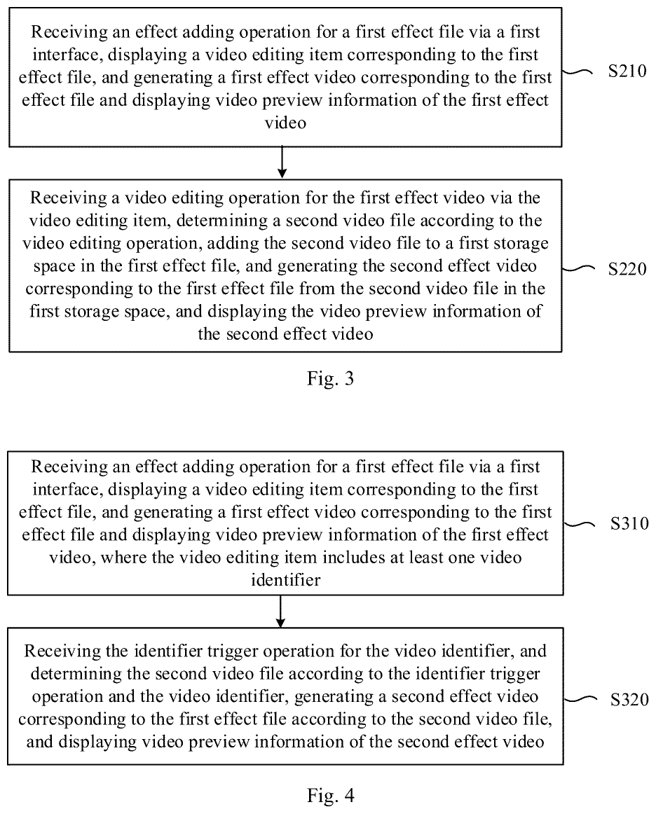

FIG. 3 is a flowchart of another effect processing method provided by an embodiment of the present disclosure. The technical solutions of the present embodiment involve further refinement of the generation way of the second effect video on the basis of the foregoing embodiment. Optionally, generating the second effect video corresponding to the first effect file according to the second video file includes: adding the second video file to a first storage space in the first effect file, and generating the second effect video corresponding to the first effect file from the second video file in the first storage space. The specific implementation may be as described as in the present embodiment. The technical features identical or similar to those in the foregoing embodiments will not be repeatedly described. As shown in FIG. 3, the method of the present embodiment may specifically include the following steps.
S210: receiving an effect adding operation for a first effect file via a first interface, displaying a video editing item corresponding to the first effect file, and generating a first effect video corresponding to the first effect file and displaying video preview information of the first effect video.
S220: receiving a video editing operation for the first effect video via the video editing item, determining a second video file according to the video editing operation, adding the second video file to a first storage space in the first effect file, and generating the second effect video corresponding to the first effect file from the second video file in the first storage space, and displaying the video preview information of the second effect video.

The first storage space may be used to store other video files than the first video file. The video file stored in the first storage space may be a video file for replacing a built-in video material in the first effect video, namely a video file for replacing the first video file corresponding to the first effect video.

In an embodiment of the present disclosure, in response to the video editing operation for the first effect video being received via the video editing item, the second video file may be determined according to the video editing operation. Further, in response to the second video file being determined, the second video file may be stored in the first storage space in the first effect file. Subsequently, the second video file in the first storage space may be processed by using the first effect file, and the second effect video corresponding to the first effect file is generated, and the video preview information of the second effect video is displayed.

It should be noted that the second video file is the video file for replacing the built-in video material in the first effect video, and an effect displaying logic corresponding to the first effect video does not change. The effect displaying logic may be preset in the first effect file. Thus, the second effect video corresponding to the first effect file may be generated according to the second video file and a preset effect displaying logic in the first effect file.

Optionally, generating the second effect video corresponding to the first effect file from the second video file in the first storage space includes: decoding the second video file in the first storage space to obtain first playback data; and playing the first playback data according to an effect displaying logic in the first effect file to obtain the second effect video corresponding to the first effect file.

Decoding is an important step in video processing, which is a process of converting a compressed video file into non-compressed original video data. The first playback data may be non-compressed video frame data corresponding to the second video file. It should be noted that the advantage of decoding the second video file is facilitating editing, playing and/or format conversion, etc. of the first playback data acquired from decoding. The effect displaying logic may be construed as a series of preset steps, rules and/or methods, etc., that should be followed when presenting effects. The effect displaying logic may correspond to the first effect file. That is to say, different effect files may correspond to different effect displaying logics. The effect displaying logic may ensure that the corresponding effect file can show the best effect on the interface.

As an optional implementation of the present embodiment of the present disclosure, after the second video file is stored in the first storage space, the second video file in the first storage space may be decoded, and the video data acquired after decoding is used as the first playback data. Further, the first playback data may be played according to the effect displaying logic in the first effect file to obtain the effect video, and the acquired effect video is used as the second effect video corresponding to the first effect file. The advantages of doing so are as follows: it is realized that a new effect video is generated according to the effect displaying logic in the first effect file and the second video file selected by the user; it is realized that only the video material in the effect video is edited; and the flexibility and intelligence level of effect processing are enhanced.

In an embodiment of the present disclosure, after the video editing operation for the first effect video is received, the received video editing operation may also be undone such that the default setting of the video material in the first effect video can be recovered. Optionally, after receiving the video editing operation for the first effect video via the video editing item, the method further includes: in response to the edit undo operation for the video editing operation, deleting the second video file from the first storage space, generating the first effect video corresponding to the first effect file according to the first video file, and displaying the video preview information of the first effect video.

The edit undo operation may be construed as an operation for undoing the received video editing operation. Optionally, the edit undo operation may include at least one of the following implementations: triggering a preset control for undoing edits; receiving an instruction for undoing edits input by the user; and detecting a trigger word associated with undoing edits in received audio information, etc.

As an optional implementation of the present embodiment of the present disclosure, in response to a control trigger operation for a preset editing undo control being received, it may be determined that the edit undo operation for the video editing operation is received. Further, in response to the edit undo operation, the memory resource occupied by the second effect video is released, and the second video file stored in the first storage space is deleted. Further, in the case where the second video file is not stored in the first storage space, the first video file may be decoded to obtain the playback data. Then, the playback data may be played according to the effect displaying logic in the first effect file to obtain the first effect video, and the video preview information of the first effect video is displayed.

According to the technical solutions of the embodiments of the present disclosure, the video editing operation for the first effect video is received via the video editing item. The second video file is determined according to the video editing operation and added to the first storage space in the first effect file. The second effect video corresponding to the first effect file is generated based on the second video file in the first storage space, and the video preview information of the second effect video is displayed. It is thus realized that a new effect video is generated based on the video file selected by the user and the flexibility of editing the first effect file is improved. Moreover, by storing the video file selected by the user in the first storage space, it is realized that the new effect video is generated without affecting the original video file.

FIG. 4 is a flowchart of another effect processing method provided by an embodiment of the present disclosure. The technical solutions of the present embodiment involve further refinement of the determination way of the second video file on the basis of the foregoing embodiments. Optionally, the video editing item includes at least one video identifier. The video editing operation includes an identifier trigger operation for the video identifier. The step of receiving the video editing operation for the first effect video via the video editing item and determining the second video file according to the video editing operation includes: receiving the identifier trigger operation for the video identifier, and determining the second video file according to the identifier trigger operation and the video identifier. The specific implementation may be as described as in the present embodiment. The technical features identical or similar to those in the foregoing embodiments will not be repeatedly described. As shown in FIG. 4, the method of the present embodiment may specifically include the following steps.

S310: receiving an effect adding operation for a first effect file via a first interface, displaying a video editing item corresponding to the first effect file, and generating a first effect video corresponding to the first effect file and displaying video preview information of the first effect video, where the video editing item includes at least one video identifier.

The video identifier may be identification information corresponding to a predetermined candidate video. The candidate video may be a video pre-stored in the video library of the application software. The video identifier may be used for identifying the corresponding candidate video. The video identifier may be any type of identification information, and optionally includes a video name, a video content thumbnail, and other identification information that may be used for identifying the video.

S320: receiving the identifier trigger operation for the video identifier, and determining the second video file according to the identifier trigger operation and the video identifier, generating a second effect video corresponding to the first effect file according to the second video file, and displaying video preview information of the second effect video.

The identifier trigger operation may be construed as an operation for triggering to identify the selected identifier. Optionally, the identifier trigger operation includes, but is not limited to, at least one of a click operation, a long press operation, a touch operation, and a slide operation.

As an optional implementation of the present embodiment of the present disclosure, in the case where the displayed video editing item corresponding to the first effect file includes at least one video identifier, the identifier trigger operation may be input for the video identifier to select the video identifier. Further, in response to the identifier trigger operation for the video identifier being received, the triggered video identifier may be determined according to the identifier trigger operation, and the video corresponding to the triggered video identifier is determined. Further, the second video file may be determined according to the determined video. Further, the second effect video corresponding to the first effect file may be generated according to the second video file, and the video preview information of the second effect video is displayed.

It should be noted that there may be at least two ways of determining the second video file according to the video file corresponding to the triggered video identifier: the second video file is determined directly according to the video corresponding to the triggered video identifier; and/or the video corresponding to the triggered video identifier is edited, and the second video file is determined according to the video acquired after editing.

In an embodiment of the present disclosure, it can be supported that the user performs self-defined editing on the video file such that the second video file acquired by editing can be fitter with the user's effect video generation result. Optionally, determining the second video file according to the identifier trigger operation and the video identifier includes: obtaining a candidate video according to the identifier trigger operation and the video identifier, and displaying a parameter editing item corresponding to the candidate video; and receiving a parameter editing operation for the candidate video via the parameter editing item, and determining the second video file according to the candidate video and the parameter editing operation. The advantages of doing so are as follows: the self-defined editing of the video based on the interactive operation between the user and the interface is realized to obtain the second video file; the flexibility of determining the second video file is improved; and the finally generated effect video can better meet the desired effect processing requirements, and the effect use experience of the effect file is enhanced.

The candidate video may be a video corresponding to the triggered video identifier. The video may be edited by the user. The parameter editing item may be configured to edit a video display parameter of the candidate video. The parameter editing item may be construed as an interactive operation entry for editing the video display parameter of the candidate video. The parameter editing item may include editing items corresponding to a plurality of editable video display parameters, and optionally at least includes a duration setting item and/or a content selecting item. The duration setting item may be configured to set the display duration of the candidate video. The duration setting item may include a plurality of display forms, and optionally includes a duration editing box and/or a time axis adjusting control, etc. The content selecting item may be configured to set a video display content of the candidate video. The content selecting item may be configured to select, from a plurality of video frames included in the candidate video, a final video frame for generating the second effect video. The content selecting item may include a plurality of display forms, and optionally includes a content selecting box. The parameter editing operation may be construed as an operation for editing the video display parameter of the candidate video. Optionally, the parameter editing operation at least includes a duration setting operation and/or a content selecting operation.

As an optional implementation of the present embodiment of the present disclosure, in response to the identifier trigger operation for the video identifier being received, the triggered video identifier may be determined according to the identifier trigger operation, and the video corresponding to the triggered video identifier is determined. The video is acquired from a storage space and used as the candidate video. Further, the parameter editing item corresponding to the candidate video may be displayed. The parameter editing item may include the duration setting item and/or the content selecting item. Further, the video display duration of the candidate video may be set via the duration setting item according to the preset upper limit of the video display duration so as to determine the video display duration of the candidate video, and/or, the video content of the candidate video may be selected in accordance with the content selecting item so as to obtain the video displaying content of the candidate video. Further, the candidate video may be processed according to the video display duration and/or the video displaying content, and the second video file is determined according to the processed video.

Exemplarily, the display form of the duration setting item is the time axis adjusting control, and the display form of the content selecting item is the content selecting box. In response to the parameter editing item corresponding to the candidate video is displayed, the video display duration of the candidate video may be determined by adjusting the time axis adjusting control. Moreover, the video displaying content of the candidate video may be selected via the content selecting box, and the video content in the content selecting box is used as the video displaying content of the candidate video.

As an optional implementation of the present embodiment of the present disclosure, the first interface may be a shooting interface on which mode identifier of a plurality of video shooting modes may be displayed. Different video shooting modes may correspond to different maximum shooting durations, i.e., upper limits of the video display duration. An identifier trigger operation for the mode identifier of the video shooting mode is received via the shooting interface, and the upper limit of the video display duration is determined according to the identifier trigger operation. Thus, the content selecting box may be generated based on the upper limit of the video display duration, and is displayed in association with the candidate video. For example, a plurality of video frames of the candidate video may be displayed. The content selecting box is displayed on the plurality of video frames of the candidate video. The total duration of a selected video clip is adjusted by adjusting the length of the content selecting box, and the selected video clip in the candidate video is adjusted by moving the position of the content selecting box.

According to the technical solutions of the embodiments of the present disclosure, the identifier trigger operation for the video identifier is received, and the second video file is determined according to the identifier trigger operation and the video identifier. The second effect video corresponding to the first effect file is generated according to the second video file, and the video preview information of the second effect video is displayed. It is thus realized that the second video file is determined based on the interactive operation between the user and the interface. The difficulty of editing the video file in the effect file is reduced, and then the effect processing efficiency is improved.

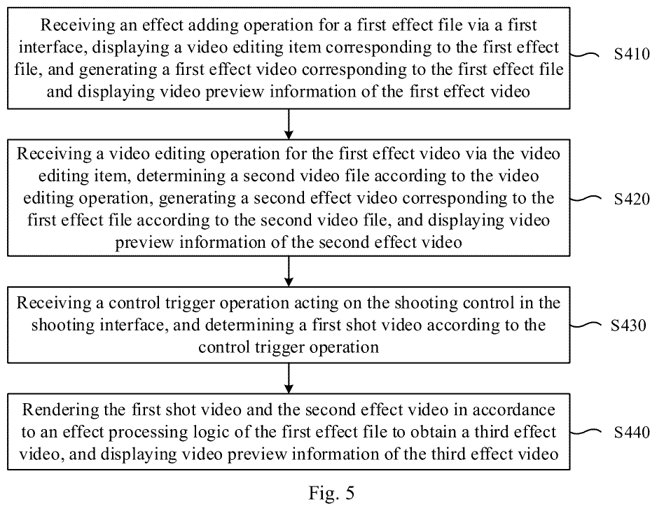

FIG. 5 is a flowchart of another effect processing method provided by an embodiment of the present disclosure. The technical solution of the present embodiment, on the basis of the foregoing embodiments, further involves shooting a first shot video after displaying the second effect video so as to generate a third effect video based on the first shot video and the second effect video. Optionally, a control trigger operation acting on a shooting control in a shooting interface is received, and a first shot video is determined according to the control trigger operation. The first shot video and the second effect video are rendered in accordance with an effect processing logic of the first effect file to obtain a third effect video, and video preview information of the third effect video is displayed. The specific implementation may be as described as in the present embodiment. The technical features identical or similar to those in the foregoing embodiments will not be repeatedly described. As shown in FIG. 5, the method of the present embodiment may specifically include the following steps.
S410: receiving an effect adding operation for a first effect file via a first interface, displaying a video editing item corresponding to the first effect file, and generating a first effect video corresponding to the first effect file and displaying video preview information of the first effect video.
S420: receiving a video editing operation for the first effect video via the video editing item, determining a second video file according to the video editing operation, generating a second effect video corresponding to the first effect file according to the second video file, and displaying video preview information of the second effect video.
S430: receiving a control trigger operation acting on the shooting control in the shooting interface, and determining a first shot video according to the control trigger operation.

The shooting interface may be an interface that supports the user in shooting images and/or videos and presents the shot content. Optionally, the first interface may include the shooting interface. Alternatively, the shooting interface may be a video shooting interface independent of the first interface. The shooting control may be a control triggered to enter a shooting flow. The first shot video may be a video shot based on a first shooting apparatus. The first shooting apparatus may be a shooting apparatus disposed on a terminal device, e.g., a smart phone camera or a tablet computer camera; or it may be an external shooting apparatus connected to the terminal device, e.g., a camera.

As an optional implementation of the present embodiment of the present disclosure, the shooting interface may be displayed. The shooting control and a shot content display region are displayed in the shooting interface. Further, in response to the control trigger operation for the shooting control being received, the shooting flow may be started. The picture displayed in the shot content display region is a picture within a field of view of the first shooting apparatus. The picture displayed in the shot content display region may be updated by moving the first shooting apparatus to shoot a video. Further, in response to a shooting completion instruction (e.g., triggering the shooting control, tapping on the screen of the terminal device, or the shooting duration reaching the preset upper limit of the video display duration) being received, the shot video may be acquired, which is used as the first shot video.

S440: rendering the first shot video and the second effect video in accordance with an effect processing logic of the first effect file to obtain a third effect video, and displaying video preview information of the third effect video.

The effect processing logic may be construed as a series of preset steps, rules and/or methods, etc., that are followed when performing effect processing on videos. The effect processing logic at least includes a rendering logic for the first shot video and the second effect video. In other words, the first shot video and the second effect video may be rendered and fused into one video according to the effect processing logic. The rendering logic for the first shot video and the second effect video may be construed as a step, a rule and/or a method, etc., that are followed when rendering the first shot video and the second effect video together. The third effect video may be an effect video acquired after rendering and fusing the first shot video and the second effect video. Optionally, the third effect video may be an effect video with the first shot video as a foreground video and the second effect video as a background video. Alternatively, the third effect video may also be an effect video with the first shot video as the background video and the second effect video as the foreground video, etc. The video form of the third effect video may correspond to the effect processing logic of the first effect file.

It should be noted that if the video duration of the first shot video is shorter than the video display duration of the second effect video, the video duration of the first shot video may be used as the video duration of the third effect video, and the second effect video is clipped based on the video duration of the first shot video. If the video duration of the first shot video is longer than the video display duration of the second effect video, the video duration of the first shot video may be used as the video duration of the third effect video, and the second effect video is cyclically played after the playing of the second effect video in the third effect video is finished until the video playing duration reaches the video duration of the first shot video.

As an optional implementation of the present embodiment of the present disclosure, after the first shot video is acquired, the first shot video and the second effect video may be rendered according to the rendering logic for the first shot video and the second effect video included in the effect processing logic of the first effect file. Further, the video acquired by rendering is used as the third effect video, and the video preview information of the third effect video is displayed.

According to the technical solutions of the embodiments of the present disclosure, the control trigger operation acting on the shooting control in the shooting interface is received, and the first shot video is determined according to the control trigger operation. Further, the first shot video and the second effect video are rendered in accordance with the effect processing logic of the first effect file to obtain the third effect video, and the video preview information of the third effect video is displayed. It is thus realized that the effect video editing function and the video shooting function are integrated into the same interface, and it is realized that when the effect video is displayed, a video is shot, and the third effect video is generated based on the shot video and the effect video. The degree of association between the user and the effect video is enhanced. The effect processing ways of the effect file are enriched. The effect display results of the effect video are enriched. Then, the effect use experience of the user for the effect file is enhanced.

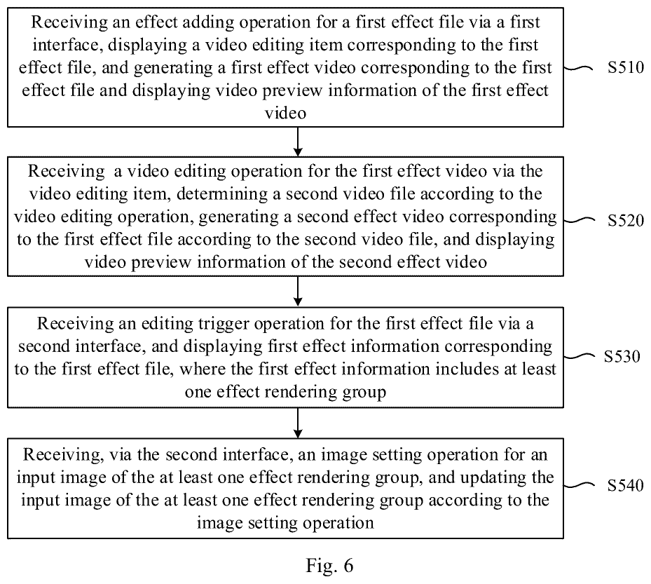

FIG. 6 is a flowchart of another effect processing method provided by an embodiment of the present disclosure. The technical solution of the present embodiment, on the basis of the foregoing embodiments, further involves inputting an editing trigger operation for the first effect file to edit first effect information corresponding to the first effect file based on the editing trigger operation. Optionally, before or after receiving the effect adding operation for the first effect file via the first interface, the method further includes: receiving an editing trigger operation for the first effect file via a second interface, and displaying first effect information corresponding to the first effect file, where the first effect information includes at least one effect rendering group; and receiving, via the second interface, an image setting operation for an input image of the at least one effect rendering group, and updating the input image of the at least one effect rendering group according to the image setting operation. The specific implementation may be as described as in the present embodiment. The technical features identical or similar to those in the foregoing embodiments will not be repeatedly described. As shown in FIG. 6, the method of the present embodiment may specifically include the following steps.
S510: receiving an effect adding operation for a first effect file via a first interface, displaying a video editing item corresponding to the first effect file, and generating a first effect video corresponding to the first effect file and displaying video preview information of the first effect video.
S520: receiving a video editing operation for the first effect video via the video editing item, determining a second video file according to the video editing operation, generating a second effect video corresponding to the first effect file according to the second video file, and displaying video preview information of the second effect video.
S530: receiving an editing trigger operation for the first effect file via a second interface, and displaying first effect information corresponding to the first effect file, where the first effect information includes at least one effect rendering group.

It should be noted that not only can the first effect file be edited via the second interface after the effect adding operation for the first effect file is received via the first interface, but also the editing trigger operation for the first effect file can be received via the second interface at any time.

The second interface may be construed as a visual editing interface that supports the user in editing effect files and displays effect edited contents. It should be noted that the second interface may be an interactive interface independent of the first interface. For example, the second interface may be an interface that supports the effect production operation, and/or, the second interface may also be an interface to which the first interface jumps for editing the effect file. In particular, in the case where the second interface is the interactive interface independent of the first interface, the editing trigger operation may include an effect file selecting operation and/or an effect file dragging operation. In the case where the second interface is the interface to which the first interface jumps for editing the effect file, the editing trigger operation may include a file editing operation for the first effect file in the first interface. The first effect information may be used for indicating an effect processing operation, an effect processing result and/or an effect processing step, etc., included in the first effect file. The effect rendering group may be used to rendering an effect image with a preset effect. In other words, the corresponding input image may be subjected to effect rendering based on the effect rendering group, and the effect image with the preset effect is output. Exemplarily, the effect rendering group may include a facial makeup effect rendering group, a face stylizing effect rendering group, a facial sticker effect rendering group, etc.

As an optional implementation of the present embodiment of the present disclosure, the second interface may be displayed, which includes a file calling control. Further, in response to a control trigger operation for the file calling control being received, a file identifier of at least one effect file may be displayed. Further, in response to an identifier trigger operation for a file identifier being received, the effect file corresponding to the triggered file identifier may be determined, and is used as the first effect file. The first effect file is called, and the first effect information corresponding to the first effect file is displayed on the second interface.

As another optional implementation of the present embodiment of the present disclosure, the first interface and the second interface may be displayed on the display interface of the terminal device. Further, the identifier dragging operation is input for the effect identifier corresponding to the first effect file displayed in the first interface. Thus, the effect identifier is dragged to a preset region in the second interface according to the identifier dragging operation. Further, in the case where the effect identifier is dragged to the preset region in the second interface, the first effect information corresponding to the first effect file may be acquired, and is displayed on the second interface.

As another optional implementation of the present embodiment of the present disclosure, in response to the effect adding operation for the first effect file being received via the first interface, the file editing operation may be input for the first effect file, and at least one file editing item is displayed. The at least one file editing item includes an effect editing item. Further, in response to a selection trigger operation for the effect editing item being received, the first interface may be adjusted to the second interface for performing effect editing on the first effect file. Further, the first effect information corresponding to the first effect file may be displayed on the second interface.

S540: receiving, via the second interface, an image setting operation for an input image of the at least one effect rendering group, and updating the input image of the at least one effect rendering group according to the image setting operation.

The input image may be an image input to the effect rendering group for effect rendering based on the effect rendering group. The image setting operation may be construed as an operation for setting an image input to the effect rendering group.

It should be noted that the number of the effect rendering groups included in the first effect information may be one or more. In the case where the first effect information includes one effect rendering group, the input image of the effect rendering group is an image to be processed that has not been processed by any effect rendering group. The image to be processed may be an original image that has not been subjected to any effect processing, e.g., a shot image and/or an image stored in the first storage space. Alternatively, the image to be processed may also be an imaged acquired after subjecting an original image to filter processing. In the case where the first effect information includes a plurality of effect rendering groups, optional input images corresponding to each effect rendering group may include output images of other effect rendering groups than the effect rendering group itself and/or images to be processed. Thus, the input image of the effect rendering group may be updated according to the optional input images corresponding to the effect rendering group.

Optionally, the first effect information includes a plurality of effect rendering groups, and updating the input image of the at least one effect rendering group according to the image setting operation includes: displaying at least one candidate image identifier corresponding to a first effect rendering group for which an input image is to be set; and receiving an identifier trigger operation acting on the at least one candidate image identifier, determining a first image corresponding to a candidate image identifier triggered by the identifier trigger operation, and setting the first image as the input image of the first effect rendering group. The advantages of doing so are as follows: self-defined setting of the input image to the effect rendering group may be realized according to the interactive operation between the user and the interface. Thus, the displaying effects of the first effect file are enriched.

The (first) effect rendering group for which an input image is to be set may be an effect rendering group needing for which an input image is to be set among a plurality of effect rendering groups. The effect rendering group for which an input image is to be set may be any effect rendering group among a plurality of effect rendering groups. The candidate image identifier may be an image identifier corresponding to an optional input image that corresponds to the effect rendering group for which an input image is to be set. The optional input image corresponding to the candidate image identifier is an image that may be set as the input image to the effect rendering group for which an input image is to be set. The candidate image identifier includes an image identifier corresponding to an output image of an effect rendering group other than the effect rendering group for which an input image is to be set among the plurality of effect rendering groups. The output image of the effect rendering group is an effect image with a preset effect rendered based on the effect rendering group.

As an optional implementation of the present embodiment of the present disclosure, the first effect information includes a plurality of effect rendering groups. In response to a selection trigger operation for an effect rendering group being received, the triggered effect rendering group may be used as the effect rendering group for which an input image is to be set. Further, the image identifier corresponding to the output image of at least one effect rendering group other than the effect rendering group for which an input image is to be set among the plurality of effect rendering groups may be determined. The determined at least one image identifier is used as at least one candidate image identifier corresponding to the effect rendering group for which an input image is the be set, and the at least one candidate image identifier is displayed on the second interface. Further, in response to the identifier trigger operation acting on the candidate image identifier being received, the triggered candidate image identifier may be determined according to the identifier trigger operation, and an image corresponding to the triggered candidate image identifier is determined. The determined image is used as the first image for the effect rendering group for which an input image is to be set. Thus, the first image may be set as the input image to the effect rendering group for which an input image is to be set.

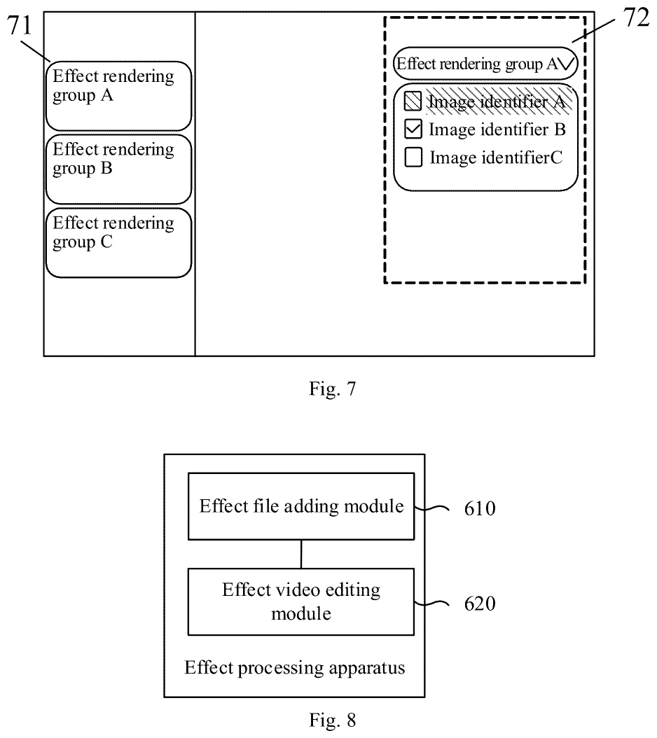

Exemplarily, FIG. 7 is a schematic diagram of an interface effect of a second interface provided by an embodiment of the present disclosure. As shown in FIG. 7, the second interface includes a first effect information display region 71 and an image setting region 72 for an effect rendering group. It is assumed that the first effect information corresponding to the first effect file includes three effect rendering groups, namely effect rendering group A, effect rendering group B, and effect rendering group C. In response to the selection trigger operation for the effect rendering group A being received, the effect rendering group A may be used as the effect rendering group for which an input image is to be set, and a rendering group name of the effect rendering group A is displayed in the image setting region 72. Further, in response to the control trigger operation for the image identifier displaying control “ [symbol] ” being received, the image identifiers may be displayed, namely image identifier A, image identifier B, and image identifier C. The image identifier A is the image identifier corresponding to the output image of the effect rendering group A. The image identifier B is the image identifier corresponding to the output image of the effect rendering group B. The image identifier C is the image identifier corresponding to the output image of the effect rendering group C. Among the three image identifiers, the image identifier B and the image identifier C may be used as candidate image identifiers corresponding to the effect rendering group A, and set to a selectable state, while the image identifier A is set to grey (with reference to the shadow in FIG. 7) such that the image identifier A is in a non-selectable state. Further, in response to the identifier trigger operation for the image identifier B being received, the image corresponding to the image identifier B may be used as the first image for the effect rendering group A, and the first image is set as the input image to the effect rendering group A.

According to the technical solutions of the embodiments of the present disclosure, the editing trigger operation for the first effect file is received via the second interface, and the first effect information corresponding to the first effect file is displayed, where the first effect information includes at least one effect rendering group. Further, the image setting operation for the input image of the at least one effect rendering group is received via the second interface, and the input image of the effect rendering group is updated according to the image setting operation. Self-defined editing of the first effect information corresponding to the first effect file is thus realized. The degree of association between the first effect file and the user is enhanced. Thus, the effect display results of the first effect file are enriched.

FIG. 8 is a structural schematic diagram of an effect processing apparatus provided by an embodiment of the present disclosure. As shown in FIG. 8, the apparatus includes an effect file adding module 610 and an effect video editing module 620. The effect file adding module 610 is configured to receive an effect adding operation for a first effect file via a first interface, display a video editing item corresponding to the first effect file, and generate a first effect video corresponding to the first effect file and display video preview information of the first effect video, where the first effect file includes a first video file. The effect video editing module 620 is configured to receive a video editing operation for the first effect video via the video editing item, determine a second video file according to the video editing operation, generate a second effect video corresponding to the first effect file according to the second video file, and show video preview information of the second effect video.

According to the technical solution of the present embodiment of the present disclosure, by using the effect file adding module 610, the effect adding operation for the first effect file is received via the first interface, and the video editing item corresponding to the first effect file is displayed. The first effect video corresponding to the first effect file is generated and the video preview information of the first effect video is displayed. It is thus realized that the effect preview display function and the effect editing function are integrated into the same interface, providing an operation entry for editing the preset video file in the first effect file. Moreover, the first effect file includes the first video file such that the effect displaying effects and the displaying effects are enriched. Further, by using the effect video editing module 620, the video editing operation for the first effect video is received via the video editing item, and the second video file is determined according to the video editing operation. The second effect video corresponding to the first effect file is generated according to the second video file, and the video preview information of the second effect video is displayed. The technical problems of limited interaction manners with effect files and single effect display result of the effect files are solved. It is realized that self-defined editing of the video file in the effect file can be performed by using a simple interface interaction operation to generate a new effect video. Thus, the flexibility of effect processing is improved. The effect display results of the effect files are enriched, and the effect use experience of the effect file is enhanced.

On the basis of any optional technical solution of the embodiments of the present disclosure, optionally, the effect video editing module 620 includes an effect video generating unit. The effect video generating unit is configured to add the second video file to a first storage space in the first effect file, and generate the second effect video corresponding to the first effect file from the second video file in the first storage space.

On the basis of any optional technical solution of the embodiments of the present disclosure, optionally, the effect video generating unit includes a video decoding sub-unit and an effect video generating sub-unit. The video decoding sub-unit is configured to decode the second video file in the first storage space to obtain first playback data. The effect video generating sub-unit is configured to play the first playback data according to an effect displaying logic in the first effect file to obtain the second effect video corresponding to the first effect file.

On the basis of any optional technical solution of the embodiments of the present disclosure, optionally, the apparatus further includes a video file deleting module. The video file deleting module is configured to, after receiving the video editing operation for the first effect video via the video editing item, in response to an edit undo operation for the video editing operation, delete the second video file from the first storage space, generate the first effect video corresponding to the first effect file according to the first video file, and show the video preview information of the first effect video.

On the basis of any optional technical solution in the embodiments of the present disclosure, optionally, the video editing item includes at least one video identifier; the video editing operation includes an identifier trigger operation for the video identifier; and the effect video editing module 620 includes a video file determining unit. The video file determining unit is configured to receive the identifier trigger operation for the video identifier, and determine the second video file according to the identifier trigger operation and the video identifier.

On the basis of any optional technical solution in the embodiments of the present disclosure, optionally, the video file determining unit includes an editing item displaying sub-unit and a video file determining sub-unit. The editing item displaying sub-unit is configured to obtain a candidate video according to the identifier trigger operation and the video identifier, and display a parameter editing item corresponding to the candidate video, where the parameter editing item at least includes a duration setting item and/or a content selecting item. The video file determining sub-unit is configured to receive a parameter editing operation for the candidate video via the parameter editing item, and determine the second video file according to the candidate video and the parameter editing operation.

On the basis of any optional technical solution in the embodiments of the present disclosure, optionally, the first interface includes a shooting interface which includes a shooting control. The apparatus further includes a shooting operation receiving module and an effect video rendering module. The shooting operation receiving module is configured to, after displaying the video preview information of the second effect video, receive a control trigger operation acting on the shooting control in the shooting interface, and determine a first shot video according to the control trigger operation. The effect video rendering module is configured to render the first shot video and the second effect video in accordance with an effect processing logic of the first effect file to obtain a third effect video, and display video preview information of the third effect video, where the effect processing logic at least includes a rendering logic for the first shot video and the second effect video.

On the basis of any optional technical solution in the embodiments of the present disclosure, optionally, the first effect file is an effect file added with a preset file identifier. The effect file adding module 610 includes an interface displaying unit, an effect file selecting unit, and an editing item displaying unit. The interface displaying unit is configured to display the first interface, where an effect identifier corresponding to at least one effect file is displayed on the first interface. The effect file selecting unit is configured to, in response to an identifier trigger operation for the effect identifier, determine a selected effect file according to the identifier trigger operation and the effect identifier. The editing item displaying unit is configured to, in response to the selected effect file being added with the preset file identifier, display the video editing item corresponding to the selected effect file.

On the basis of any optional technical solution of the embodiments of the present disclosure, optionally, the apparatus further includes an effect information displaying module and an image updating module. The effect information displaying module is configured to, before or after receiving the effect adding operation for the first effect file via the first interface, receive an editing trigger operation for the first effect file via a second interface, and display first effect information corresponding to the first effect file, where the first effect information includes at least one effect rendering group which is used to render an effect image of a preset effect. The image updating module is configured to receive, via the second interface, an image setting operation for an input image of the at least one effect rendering group, and update the input image of the at least one effect rendering group according to the image setting operation.

On the basis of any optional technical solution in the embodiments of the present disclosure, optionally, the first effect information includes a plurality of effect rendering groups. The image updating module includes an image identifier displaying unit and an image setting unit. The image identifier displaying unit is configured to display at least one candidate image identifier corresponding to the first effect rendering group for which an input image is to be set, where the at least one candidate image identifier includes an image identifier corresponding to an output image of an effect rendering group other than the first effect rendering group among the plurality of effect rendering groups. The image setting unit is configured to receive an identifier trigger operation acting on the at least one candidate image identifier, determine a first image corresponding to a candidate image identifier triggered by the identifier trigger operation, and set the first image as the input image of the first effect rendering group.

The effect processing apparatus provided by the embodiment of the present disclosure may perform the effect processing method provided by any embodiment of the present disclosure and has corresponding functional modules for performing the effect processing method and corresponding beneficial effects.

It should be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

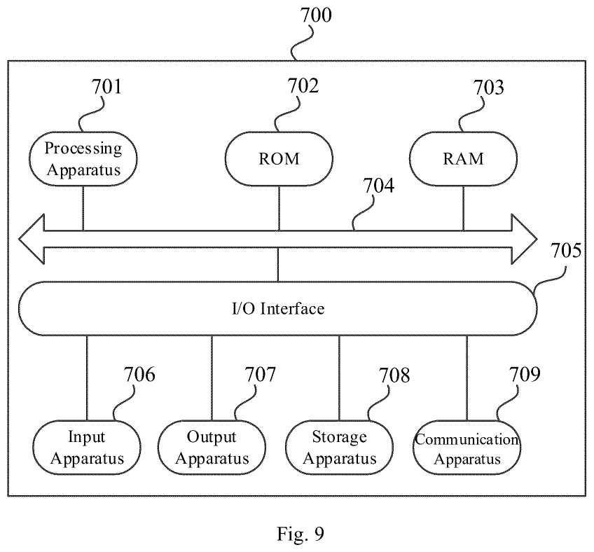

Referring to FIG. 9, FIG. 9 illustrates a schematic structural diagram of an electronic device (eg, a terminal device or a server) 700 suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected through a bus 704. An input/output (I/O) interface 705 is also connected to the bus 704.

Usually, the following apparatuses may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 9 illustrates the electronic device 700 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

The names of the messages or information exchanged between a plurality of apparatuses in the embodiments of the present disclosure are for illustrative purposes only and are not intended to limit the scope of these messages or information.

The electronic device provided by the embodiments of the present disclosure and the effect processing method provided by the above embodiments belong to the same inventive concept, and technical details not exhaustively described in the present embodiment may be referred to the above embodiments, and the present embodiment has the same beneficial effects as the above embodiments.

The present disclosure provides a computer storage medium on which a computer program is stored. When the program is executed by a processor, the effect processing method provided in the above embodiment is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, example 1 provides an effect processing method, including: receiving an effect adding operation for a first effect file via a first interface, displaying a video editing item corresponding to the first effect file, and generating a first effect video corresponding to the first effect file and displaying video preview information of the first effect video, where the first effect file includes a first video file; and
receiving a video editing operation for the first effect video via the video editing item, determining a second video file according to the video editing operation, generating a second effect video corresponding to the first effect file according to the second video file, and displaying video preview information of the second effect video.

According to one or more embodiments of the present disclosure, example 2 provides the method according to example 1, further including: optionally, the generating the second effect video corresponding to the first effect file according to the second video file includes:
adding the second video file to a first storage space in the first effect file, and generating the second effect video corresponding to the first effect file from the second video file in the first storage space.

According to one or more embodiments of the present disclosure, example 3 provides the method according to example 2, further including: optionally, the generating the second effect video corresponding to the first effect file from the second video file in the first storage space includes:
decoding the second video file in the first storage space to obtain first playback data; and
playing the first playback data according to an effect displaying logic in the first effect file to obtain the second effect video corresponding to the first effect file.

According to one or more embodiments of the present disclosure, example 4 provides the method according to example 2, further including: optionally, after receiving the video editing operation for the first effect video via the video editing item,
in response to an edit undo operation for the video editing operation, deleting the second video file from the first storage space, generating the first effect video corresponding to the first effect file according to the first video file, and displaying the video preview information of the first effect video.

According to one or more embodiments of the present disclosure, example 5 provides the method according to example 1, further including: optionally, the video editing item includes at least one video identifier; the video editing operation includes an identifier trigger operation for the video identifier; and
the receiving the video editing operation for the first effect video via the video editing item, determining the second video file according to the video editing operation includes: receiving the identifier trigger operation for the video identifier, and determining the second video file according to the identifier trigger operation and the video identifier.

According to one or more embodiments of the present disclosure, example 6 provides the method according to example 5, further including: optionally, the determining the second video file according to the identifier trigger operation and the video identifier including: obtaining a candidate video according to the identifier trigger operation and the video identifier, and displaying a parameter editing item corresponding to the candidate video, where the parameter editing item at least includes a duration setting item and/or a content selecting item; and receiving a parameter editing operation for the candidate video via the parameter editing item, and determining the second video file according to the candidate video and the parameter editing operation.

According to one or more embodiments of the present disclosure, example 7 provides the method according to example 1, further including: optionally, the first interface includes a shooting interface which includes a shooting control; and after displaying the video preview information of the second effect video, receiving a control trigger operation acting on the shooting control in the shooting interface, and determining a first shot video according to the control trigger operation; and rendering the first shot video and the second effect video in accordance with an effect processing logic of the first effect file to obtain a third effect video, and displaying video preview information of the third effect video, where the effect processing logic at least includes a rendering logic for the first shot video and the second effect video.

According to one or more embodiments of the present disclosure, example 8 provides the method according to example 1, further including: optionally, the first effect file is an effect file added with a preset file identifier; and the receiving the effect adding operation for the first effect file via the first interface, displaying the video editing item corresponding to the first effect file includes: displaying the first interface, where an effect identifier corresponding to at least one effect file is displayed on the first interface; in response to an identifier trigger operation for the effect identifier, determining a selected effect file according to the identifier trigger operation and the effect identifier; and in response to the selected effect file being added with the preset file identifier, displaying the video editing item corresponding to the selected effect file.

According to one or more embodiments of the present disclosure, example 2 provides the method according to example 1, further including: optionally, before or after receiving the effect adding operation for the first effect file via the first interface, receiving an editing trigger operation for the first effect file via a second interface, and displaying first effect information corresponding to the first effect file, where the first effect information includes at least one effect rendering group which is used to render an effect image of a preset effect; and receiving, via the second interface, an image setting operation for an input image of the at least one effect rendering group, and updating the input image of the at least one effect rendering group according to the image setting operation.

According to one or more embodiments of the present disclosure, example 10 provides the method according to example 9, further including: optionally, the first effect information includes a plurality of effect rendering groups; and the updating the input image of the at least one effect rendering group according to the image setting operation includes: displaying at least one candidate image identifier corresponding to a first effect rendering group for which an input image is to be set, where the at least one candidate image identifier includes an image identifier corresponding to an output image of an effect rendering group other than the first effect rendering group among the plurality of effect rendering groups; and receiving an identifier trigger operation acting on the at least one candidate image identifier, determining a first image corresponding to a candidate image identifier triggered by the identifier trigger operation, and setting the first image as the input image of the first effect rendering group.

According to one or more embodiments of the present disclosure, example 1 provides an effect processing apparatus, including: an effect file adding module configured to receive an effect adding operation for a first effect file via a first interface, display a video editing item corresponding to the first effect file, and generate a first effect video corresponding to the first effect file and display video preview information of the first effect video, where the first effect file includes a first video file; and an effect video editing module configured to receive a video editing operation for the first effect video via the video editing item, determine a second video file according to the video editing operation, generate a second effect video corresponding to the first effect file according to the second video file, and show video preview information of the second effect video.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: receive an effect adding operation for a first effect file via a first interface, display a video editing item corresponding to the first effect file, and generate a first effect video corresponding to the first effect file and display video preview information of the first effect video, where the first effect file includes a first video file; and receive a video editing operation for the first effect video via the video editing item, determine a second video file according to the video editing operation, generate a second effect video corresponding to the first effect file according to the second video file, and show video preview information of the second effect video.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases. For example, the effect file adding module may also be described as “a module for receiving an effect adding operation for a first effect file”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect processing method, comprising:
receiving an effect adding operation for a first effect file via a first interface, displaying a video editing item corresponding to the first effect file, and generating a first effect video corresponding to the first effect file and displaying video preview information of the first effect video, wherein the first effect file comprises a first video file; and
receiving a video editing operation for the first effect video via the video editing item, determining a second video file according to the video editing operation, generating a second effect video corresponding to the first effect file according to the second video file, and displaying video preview information of the second effect video.

2. The effect processing method according to claim 1, wherein the generating the second effect video corresponding to the first effect file according to the second video file comprises:
adding the second video file to a first storage space in the first effect file, and generating the second effect video corresponding to the first effect file from the second video file in the first storage space.

3. The effect processing method according to claim 2, wherein the generating the second effect video corresponding to the first effect file from the second video file in the first storage space comprises:
decoding the second video file in the first storage space to obtain first playback data; and
playing the first playback data according to an effect displaying logic in the first effect file to obtain the second effect video corresponding to the first effect file.

4. The effect processing method according to claim 2, after receiving the video editing operation for the first effect video via the video editing item, further comprising:
in response to an edit undo operation for the video editing operation, deleting the second video file from the first storage space, generating the first effect video corresponding to the first effect file according to the first video file, and displaying the video preview information of the first effect video.

5. The effect processing method according to claim 1, wherein the video editing item comprises at least one video identifier; the video editing operation comprises an identifier trigger operation for the video identifier; and
the receiving the video editing operation for the first effect video via the video editing item, determining the second video file according to the video editing operation comprises:
receiving the identifier trigger operation for the video identifier, and determining the second video file according to the identifier trigger operation and the video identifier.

6. The effect processing method according to claim 5, wherein the determining the second video file according to the identifier trigger operation and the video identifier comprises:
obtaining a candidate video according to the identifier trigger operation and the video identifier, and displaying a parameter editing item corresponding to the candidate video, wherein the parameter editing item at least comprises a duration setting item and/or a content selecting item; and
receiving a parameter editing operation for the candidate video via the parameter editing item, and determining the second video file according to the candidate video and the parameter editing operation.

7. The effect processing method according to claim 1, wherein the first interface comprises a shooting interface which comprises a shooting control; and after displaying the video preview information of the second effect video, the effect processing method further comprises:
receiving a control trigger operation acting on the shooting control in the shooting interface, and determining a first shot video according to the control trigger operation; and
rendering the first shot video and the second effect video in accordance with an effect processing logic of the first effect file to obtain a third effect video, and displaying video preview information of the third effect video, wherein the effect processing logic at least comprises a rendering logic for the first shot video and the second effect video.

8. The effect processing method according to claim 1, wherein the first effect file is an effect file added with a preset file identifier; and the receiving the effect adding operation for the first effect file via the first interface, displaying the video editing item corresponding to the first effect file comprises:
displaying the first interface, wherein an effect identifier corresponding to at least one effect file is displayed on the first interface;
in response to an identifier trigger operation for the effect identifier, determining a selected effect file according to the identifier trigger operation and the effect identifier; and
in response to the selected effect file being added with the preset file identifier, displaying the video editing item corresponding to the selected effect file.

9. The effect processing method according to claim 1, wherein before or after receiving the effect adding operation for the first effect file via the first interface, the effect processing method further comprises:
receiving an editing trigger operation for the first effect file via a second interface, and displaying first effect information corresponding to the first effect file, wherein the first effect information comprises at least one effect rendering group which is used to render an effect image of a preset effect; and
receiving, via the second interface, an image setting operation for an input image of the at least one effect rendering group, and updating the input image of the at least one effect rendering group according to the image setting operation.

10. The effect processing method according to claim 9, wherein the first effect information comprises a plurality of effect rendering groups; and the updating the input image of the at least one effect rendering group according to the image setting operation comprises:
displaying at least one candidate image identifier corresponding to a first effect rendering group for which an input image is to be set, wherein the at least one candidate image identifier comprises an image identifier corresponding to an output image of an effect rendering group other than the first effect rendering group among the plurality of effect rendering groups; and
receiving an identifier trigger operation acting on the at least one candidate image identifier, determining a first image corresponding to the at least one candidate image identifier triggered by the identifier trigger operation, and setting the first image as the input image of the first effect rendering group.

11. An electronic device, comprising:
one or more processors; and
a storage apparatus, configured to store one or more programs,
wherein the one or more programs, when executed by the one or more processors, cause the one or more processors to implement an effect processing method, which comprises:
receiving an effect adding operation for a first effect file via a first interface, displaying a video editing item corresponding to the first effect file, and generating a first effect video corresponding to the first effect file and displaying video preview information of the first effect video, wherein the first effect file comprises a first video file; and
receiving a video editing operation for the first effect video via the video editing item, determining a second video file according to the video editing operation, generating a second effect video corresponding to the first effect file according to the second video file, and displaying video preview information of the second effect video.

12. The electronic device according to claim 11, wherein the generating the second effect video corresponding to the first effect file according to the second video file comprises:
adding the second video file to a first storage space in the first effect file, and generating the second effect video corresponding to the first effect file from the second video file in the first storage space.

13. The electronic device according to claim 12, wherein the generating the second effect video corresponding to the first effect file from the second video file in the first storage space comprises:
decoding the second video file in the first storage space to obtain first playback data; and
playing the first playback data according to an effect displaying logic in the first effect file to obtain the second effect video corresponding to the first effect file.

14. The electronic device according to claim 12, wherein after receiving the video editing operation for the first effect video via the video editing item, the effect processing method further comprises:
in response to an edit undo operation for the video editing operation, deleting the second video file from the first storage space, generating the first effect video corresponding to the first effect file according to the first video file, and displaying the video preview information of the first effect video.

15. The electronic device according to claim 11, wherein the video editing item comprises at least one video identifier; the video editing operation comprises an identifier trigger operation for the video identifier; and
the receiving the video editing operation for the first effect video via the video editing item, determining the second video file according to the video editing operation comprises:
receiving the identifier trigger operation for the video identifier, and determining the second video file according to the identifier trigger operation and the video identifier.

16. The electronic device according to claim 15, wherein the determining the second video file according to the identifier trigger operation and the video identifier comprises:
obtaining a candidate video according to the identifier trigger operation and the video identifier, and displaying a parameter editing item corresponding to the candidate video, wherein the parameter editing item at least comprises a duration setting item and/or a content selecting item; and
receiving a parameter editing operation for the candidate video via the parameter editing item, and determining the second video file according to the candidate video and the parameter editing operation.

17. The electronic device according to claim 11, wherein the first interface comprises a shooting interface which comprises a shooting control; and after displaying the video preview information of the second effect video, the effect processing method further comprises:
receiving a control trigger operation acting on the shooting control in the shooting interface, and determining a first shot video according to the control trigger operation; and
rendering the first shot video and the second effect video in accordance with an effect processing logic of the first effect file to obtain a third effect video, and displaying video preview information of the third effect video, wherein the effect processing logic at least comprises a rendering logic for the first shot video and the second effect video.

18. The electronic device according to claim 11, wherein the first effect file is an effect file added with a preset file identifier; and the receiving the effect adding operation for the first effect file via the first interface, displaying the video editing item corresponding to the first effect file comprises:
displaying the first interface, wherein an effect identifier corresponding to at least one effect file is displayed on the first interface;
in response to an identifier trigger operation for the effect identifier, determining a selected effect file according to the identifier trigger operation and the effect identifier; and
in response to the selected effect file being added with the preset file identifier, displaying the video editing item corresponding to the selected effect file.

19. The electronic device according to claim 11, wherein before or after receiving the effect adding operation for the first effect file via the first interface, the effect processing method further comprises:
receiving an editing trigger operation for the first effect file via a second interface, and displaying first effect information corresponding to the first effect file, wherein the first effect information comprises at least one effect rendering group which is used to render an effect image of a preset effect; and
receiving, via the second interface, an image setting operation for an input image of the at least one effect rendering group, and updating the input image of the at least one effect rendering group according to the image setting operation.

20. A non-transitory storage medium comprising computer-executable instructions, wherein the computer-executable instructions, when executed by a computer processor, implement an effect processing method, which comprises:
receiving an effect adding operation for a first effect file via a first interface, displaying a video editing item corresponding to the first effect file, and generating a first effect video corresponding to the first effect file and displaying video preview information of the first effect video, wherein the first effect file comprises a first video file; and
receiving a video editing operation for the first effect video via the video editing item, determining a second video file according to the video editing operation, generating a second effect video corresponding to the first effect file according to the second video file, and displaying video preview information of the second effect video.
